(19) United States
(12) Patent Application Publication
(10) Pub. No.: US 2013/0273399 A1
(43) Pub. Date: Oct. 17, 2013

(54) Integrated and Optimized Battery Cooling Blower and Manifold

(71) Applicants: Andrew P. Oury, Troy, MI (US); Christopher A. Schlaupitz, White Lake, MI (US); Chih-Cheng Hsu, Rochester Hills, MI (US); Zhongying Shi, Novi, MI (US)

(72) Inventors: Andrew P. Oury, Troy, MI (US); Christopher A. Schlaupitz, White Lake, MI (US); Chih-Cheng Hsu, Rochester Hills, MI (US); Zhongying Shi, Novi, MI (US)

(73) Assignee: GM GLOBAL TECHNOLOGY OPERATIONS LLC, Detroit, MI (US)

(21) Appl. No.: 13/448,823

(22) Filed: Apr. 17, 2012

(51) Int. Cl. H01M 10/50

(52) U.S. Cl. 429/71

(57) ABSTRACT

A battery pack having an integrated cooling system which includes a first battery module including a first plurality of battery cells separated by a first plurality of channels, a second battery module including a second plurality of battery cells separated by a second plurality of channels, and a fan that creates air flow between the first and second plurality of channels. The battery pack also includes a manifold having a first conduit section lead from the fan to the first plurality of channels and a second conduit section lead from the fan to the second plurality of channels. Characteristically, the fan is positioned in the manifold where it creates the air flow that is directed by the manifold to the first plurality of channels and the second plurality of channels.

### FIELD OF THE INVENTION

In at least one aspect, the present invention relates to cooling systems for battery packs.

### BACKGROUND

Large capacity rechargeable batteries are currently being investigated for use in electric vehicles. The ultimate feasibility of electric vehicles depends on significantly reducing the associated costs. Reduction in the costs of battery assemblies is particularly important.

Lithium ion batteries are an important type of battery technology. Most battery assemblies, including lithium ion battery assemblies, include a plurality of individual electrochemical cells. Typically, such electrochemical cells include an anode and a cathode. Typically, the anode includes a metal sheet or foil (usually copper metal) over-coated with a graphitic layer. Similarly, the cathode usually includes a metal sheet or foil (usually aluminum metal) over-coated with a lithium-containing layer. Finally, electrochemical cells include an electrolyte which is interposed between the anode and the cathode. Terminals allow the generated electricity to be used in an external circuit. Electrochemical cells produce electricity via an electrochemical reaction.

For high power application, a plurality of battery cells are utilized and assembled into a battery module. Moreover, such battery modules are assembled into battery packs which include a cooling system and related electronics for operating the batteries. The cooling system typically includes a blower to cool each battery module. Although the prior art battery cooling systems work reasonably well, weight remains a constant issue, especially in automotive applications.

Accordingly, there is a need for improved battery cooling systems, particularly for automotive applications.

### SUMMARY OF THE INVENTION

The present invention solves one or more problems of the prior art by providing a battery pack with an integrated cooling system. The battery pack includes a first battery module including a first plurality of battery cells separated by a first plurality of channels, a second battery module including a second plurality of battery cells separated by a second plurality of channels, and a fan (i.e., blower) that creates air flow between the first and second plurality of channels. The battery pack also includes a manifold having a first conduit section leading from the fan to the first plurality of channels and a second conduit section leading from the fan to the second plurality of channels. Characteristically, the fan is positioned in the manifold where it creates the air flow that is directed by the manifold to the first plurality of channels and the second plurality of channels.

In another embodiment, a battery cooling system is provided. The battery cooling system includes a battery tray for receiving a first battery module and a second battery module. The first battery module includes a first plurality of battery cells separated by a first plurality of channels while the second battery module includes a second plurality of battery cells separated by a first plurality of channels. The cooling system also includes a fan and a manifold. The fan creates air flow between the first and second plurality of channels. The manifold includes a first conduit section leading from the fan to the first plurality of channels and a second conduit section leading from the fan to the second plurality of channels. The fan is positioned in the manifold where it creates the air flow that is directed by the manifold to the first plurality of channels and the second plurality of channels.

In still another embodiment, a battery pack with an integrated cooling system is provided. The battery pack includes a first battery module including a first plurality of battery cells separated by a first plurality of channels, a second battery module including a second plurality of battery cells separated by a second plurality of channels, and a fan that creates air flow between the first and second plurality of channels. The battery pack includes also a manifold having a first conduit section leading from the fan to the first plurality of channels and a second conduit section leading from the fan to the second plurality of channels. Characteristically, the fan is positioned in the manifold where it creates the air flow that is directed by the manifold to the first plurality of channels and the second plurality of channels. Characteristically, the manifold has a curved side that directs flow towards the second plurality of channels. The manifold also includes a second curved side, a third curved side, and a fourth curved side wherein the first curved side and the second curved side define a first indentation into the manifold and the third curved side and the fourth curved side define a second indentation into the manifold.

Advantageously, the embodiments set forth above provide improved blower efficiency, reduced pressure drop, and evenly distributed air in the directions to the two battery modules. The present designs allow for elimination of the blower scroll housing. The elimination of this component allows a weight and cost reduction by having a single fan to be utilized unlike the typical prior art applications in which two blowers are used to cool two battery modules. Moreover, a larger blower may be utilized because of the elimination of the scroll housing.

### BRIEF DESCRIPTION OF THE DRAWINGS

Exemplary embodiments of the present invention will become more fully understood from the detailed description and the accompanying drawings, wherein:

FIG. 1 is a perspective view of the battery pack with an integral cooling system;

FIG. 2 is a schematic cross section of the battery pack of FIG. 1;

FIG. 3 is a cross section through a cooling manifold included in the battery pack of FIG. 1;

FIG. 4 is a perspective view of a battery tray with a cooling manifold attached thereto;

FIG. 5A provides the relative flows at the entrance ends of a plurality of channels in a battery module;

FIG. 5B provides the relative flows at the entrance ends of a plurality of channels in another battery module;

FIG. 6 is a schematic illustration of an embodiment of a battery pack with an integral cooling system;

FIG. 7A provides a schematic cross section of a fan having backwardly curve blades;

FIG. 7B provides a schematic cross section of a fan having forwardly curve blades;

FIG. 8 is a schematic cross section of a fan surrounded by a plurality of stationary stators;

FIG. 9 is a schematic cross section of a fan surrounded by a plurality of stationary volutes; and

FIG. 10 is a schematic illustration of a cooling system using a plurality of vanes to direct cooling air to the battery modules.

### DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

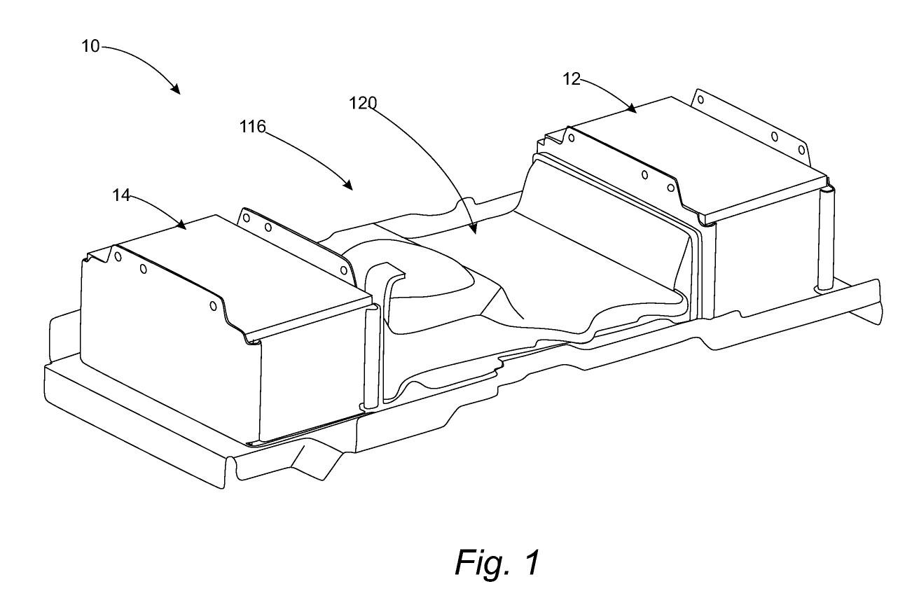

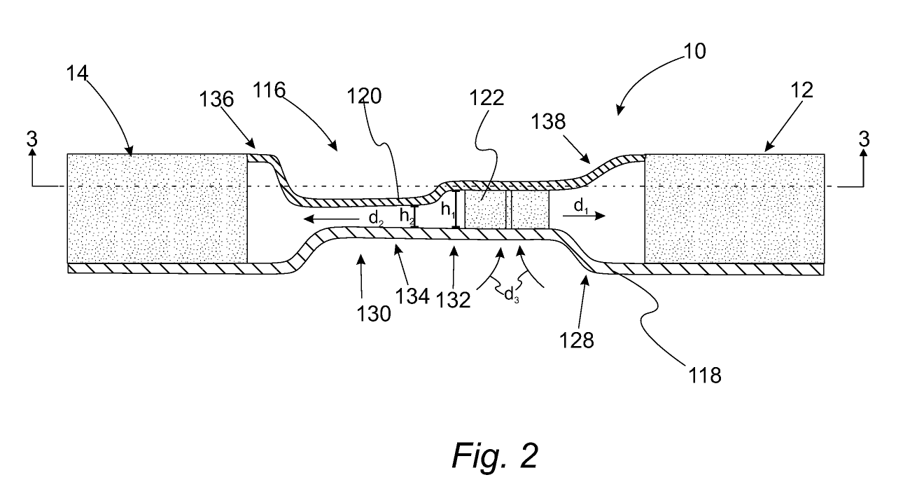

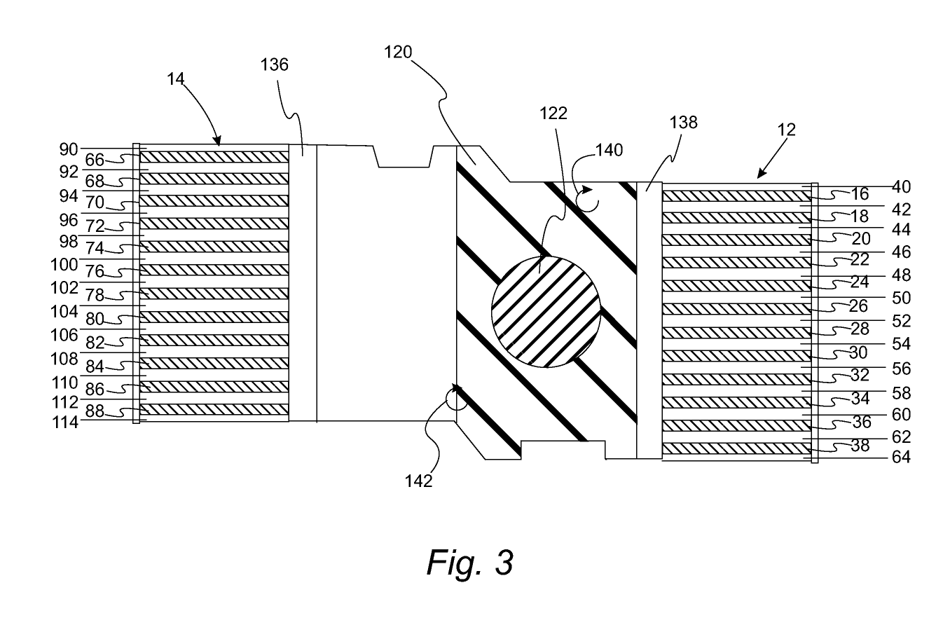

With reference to FIGS. 1, 2, and 3, schematic illustrations of a battery pack with an integrated cooling system are provided. FIG. 1 is a perspective view of the battery pack. FIG. 2 is a schematic cross section of the battery pack. FIG. 3 is a cross section through a cooling manifold. Battery pack 10 includes battery modules 12, 14. Battery module 12 includes battery cells 16-38 separated by a first plurality of channels 40-64 through which cooling air flows. Similarly, battery module 14 includes battery cells 66-88 separated by a second plurality of channels 90-112 through which cooling air flows. In a refinement, the separation between battery cells is from about 1 to 4 millimeters. Although the present embodiment is not limited to any particular type of battery cell, lithium battery cells are particularly useful. Battery pack 10 also includes cooling system 116. Cooling system 116 includes battery tray 118 and manifold 120 with fan 122 positioned therein. As used herein, the term “fan” includes other equivalent prior art terms such as “blower” or “squirrel cage.” In a refinement, manifold 120 and battery tray 118 are each independently formed from a plastic (e.g., polypropylene) or a metal (e.g. stainless steel, aluminum, etc). Fan 122 generally includes a plurality of fan blades as set forth below. Fan 122 creates air flow between the first and second plurality of channels by rotating along a rotation direction. In particular, air flows along directions d₁ and d₂ towards channels 40-64 and 90-112. Manifold 120 includes first conduit section 128 which leads from fan 122 to battery module 12 and, therefore, channels 40-64. Manifold 120 includes second conduit section 130 which leads from fan 122 to battery module 12 and, therefore, channels 40-64. Although the battery pack of the present embodiment is not limited to any dimension, in a refinement, the battery pack has a length from about 400 to 1000 mm, a width from about 200 to 400 mm, and a height from about 100 to 300 mm. In a refinement, the manifold has a length from about 250 mm to about 500 mm and the battery modules have a length from about 150 mm to about 300 mm. In still another refinement, the pressure drop from the vicinity of fan 122 to the entrance of the channels in either battery module is from about 10 to about 25 Pa with a total pressure drop across the battery pack form about 80 to about 120 Pa.

Still referring to FIGS. 1, 2, and 3, manifold 120 includes a manifold section 132 which has height h₁ and manifold section 134 which has a height h₂. Characteristically, height h₁ is greater than h₂. Although the present invention is not limited to any particular dimensions, in a refinement, h₁ is from about 20 to 50 mm and h₂ is from about 30 to about 70 mm. Height h₁ is of sufficient height to accommodate fan 122 so that fan blades of sufficient height are utilized. Manifold section 134 is included in conduit section 130 and flares out to form conduit section 136 which matches the dimensions of channels 90-112. Similarly, manifold section 132 connects to conduit section 130 which flares out to conduit section 138 which matches the dimensions of channels 90-112.

Still referring to FIG. 3, computational fluid dynamics modeling (CFD) identifies several regions of stagnant flow. Two such regions are indicated by item numbers 140 and 142. The reduction of such stagnation regions is accomplished by the embodiments set forth below.

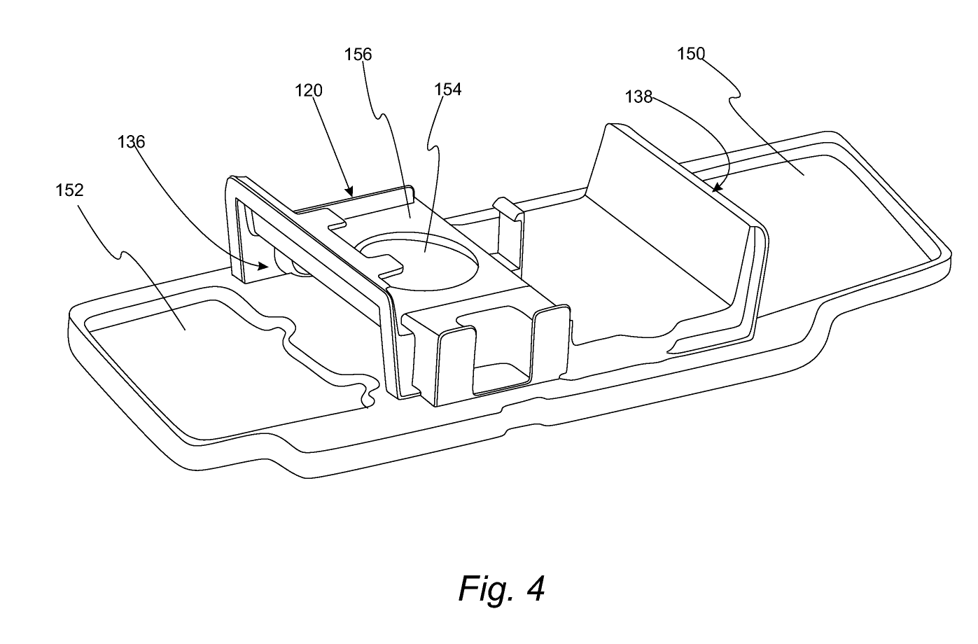

With reference to FIGS. 2 and 4, battery assembly 10 also includes battery tray 118. FIG. 4 is a perspective view of battery tray 118 with manifold 120 attached thereto. Battery tray 118 includes battery receiving sections 150 and 152 onto which battery modules 12 and 14 are respectfully mounted. Manifold 120 is also mounted onto battery tray 118. FIG. 4 also indicates conduit sections 136 and 138. Fan 122 is passed into manifold 120 through opening 154 in upper surface 146.

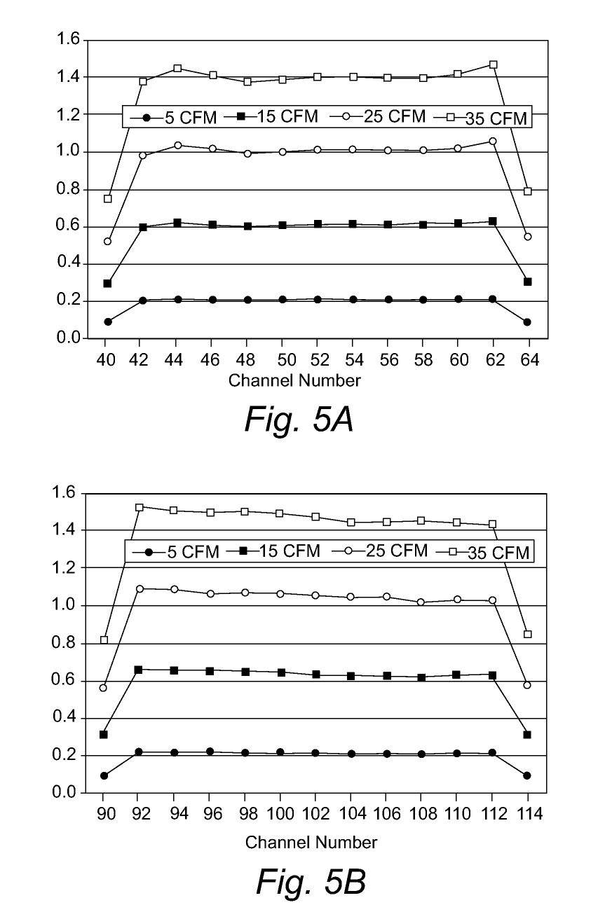

With reference to FIGS. 2, 5A, and 5B, the uniformity of the flow pattern is formed by battery cooling system 116. FIGS. 5A provides the relative flows at the entrance ends of channels 40-64 while FIG. 5B provides the relative flows at the entrance ends of channels 90-114 as determined by CFD. The flow is observed to be quite uniform over the central channels 42-62 of battery module 12 and channels 92-112 of battery module 14 for air flows of 5 to 35 cubic feet per minute (CFM). The end channels 40, 64, 90, and 114 are purposely designed to have low flows by reducing the channel separation due to the fact that these channels only cool a single battery cell while the other channel cools two cells. The flows provided in FIGS. 5A and 5B are the total flows to both battery modules. Therefore, the flow to a single battery module is about half. Moreover, for the CFD modeling in these figures, the battery cell separation is about 3 mm for the central channels and about 2 mm for the end channels.

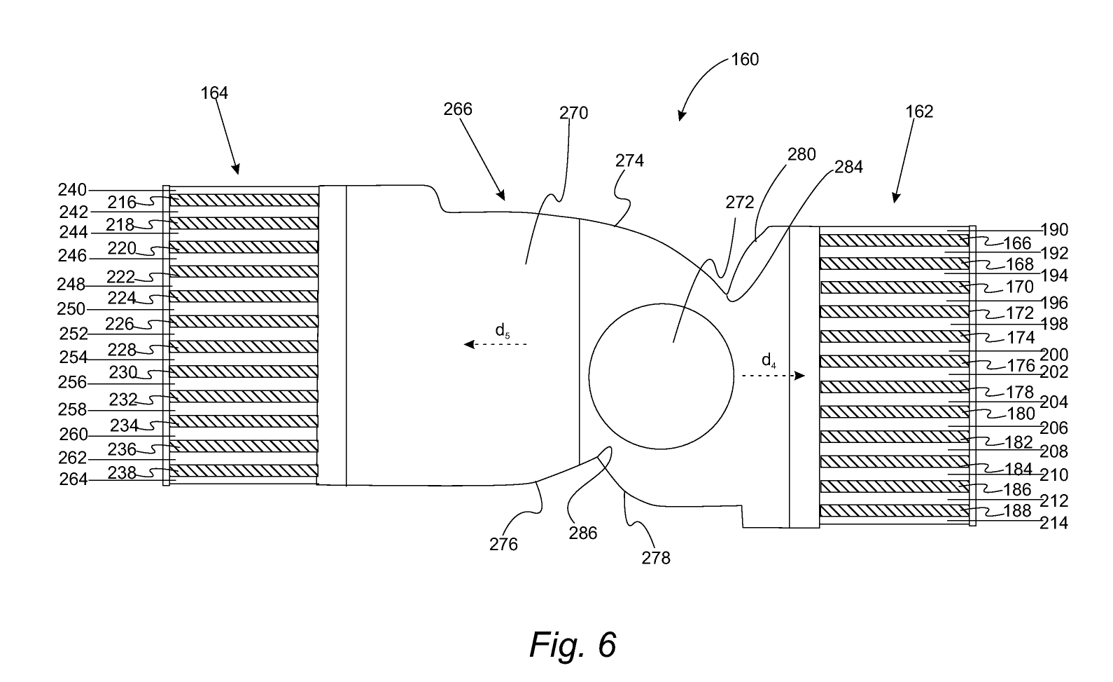

With reference to FIG. 6, an embodiment of a battery pack with reduced incidence of stagnation regions is provided. It should be appreciated that the cross section of FIG. 2 is still generally applicable to the present embodiment. The battery pack of the present embodiment is of the same general design as the battery pack described in FIGS. 1-4 except that the manifold has a different geometrical design. Battery pack 160 includes first battery module 162 and second battery module 164. Battery module 12 includes battery cells 166-188 separated by a first plurality of channels 190-214 through which cooling air flows. Similarly, battery module 164 includes battery cells 216-238 separated by a second plurality of channels 240-262 through which cooling air flows. Battery pack 160 also includes cooling system 266. Cooling system 266 includes a battery tray as set forth above and manifold 270 with fan 272 positioned therein. In a refinement, manifold 270 and the battery tray are each independently formed from a plastic (e.g., polypropylene) or a metal (e.g. stainless steel, aluminum, etc.). Fan 272 generally includes a plurality of fan blades as set forth below. Fan 272 creates air flow between the first and second plurality of channels by rotating along a rotation direction. In particular, air flows along directions d₄ and d₅ towards channels 166-188 and 240-262, respectively. Manifold 270 includes curved side 274 directing air flow from fan 272 toward the second plurality of channels 240-264. Manifold 270 also includes curved side 276, 278, and 280. Side 276 also directs flow towards the second plurality of channels 240-264 while curved sides 278 and 280 assist in directing air towards flow the first plurality of channels 190-214. Curved sides 274 and 280 combine together to form indentation 284 which protrudes into manifold 270. Curved sides 276 and 278 combine together to form indentation 286 which protrudes into manifold 270. Protrusions 284 and 286 advantageously act to reduce stagnations regions.

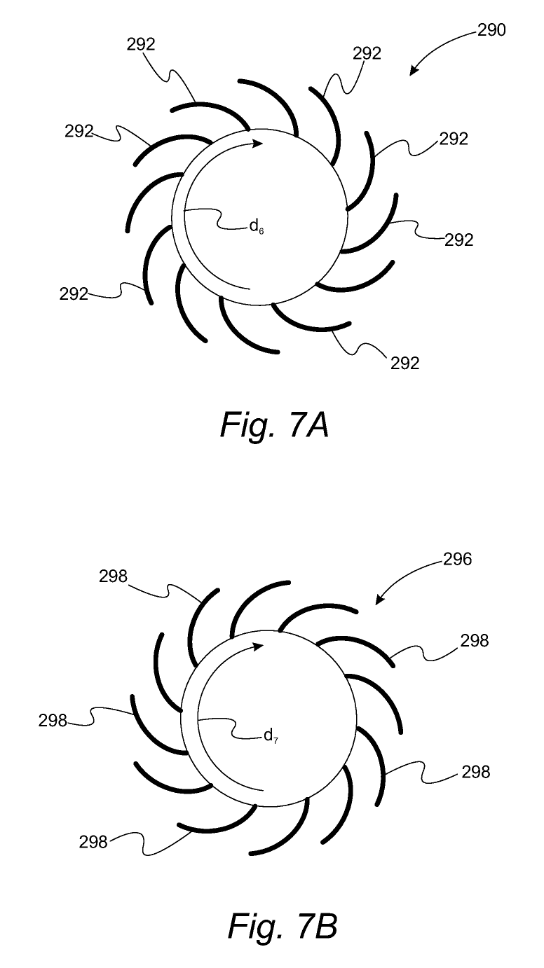

With reference to FIGS. 7A and 7B, schematic illustrations of fans used in the battery cooling systems set forth above is provided. FIG. 7A provides a schematic cross section of a fan having backwardly curve blades. Fan 290 includes a plurality of fan blades 292 which are backwardly curved. In this context, backwardly curved is relative to rotation direction d₆ of fan 290. FIG. 7B provides a schematic cross section of a fan having forwardly curve blades. Fan 296 includes a plurality of fan blades 298 which are forwardly curved. In this context, forwardly curved is relative to rotation direction d₇ of fan 296.

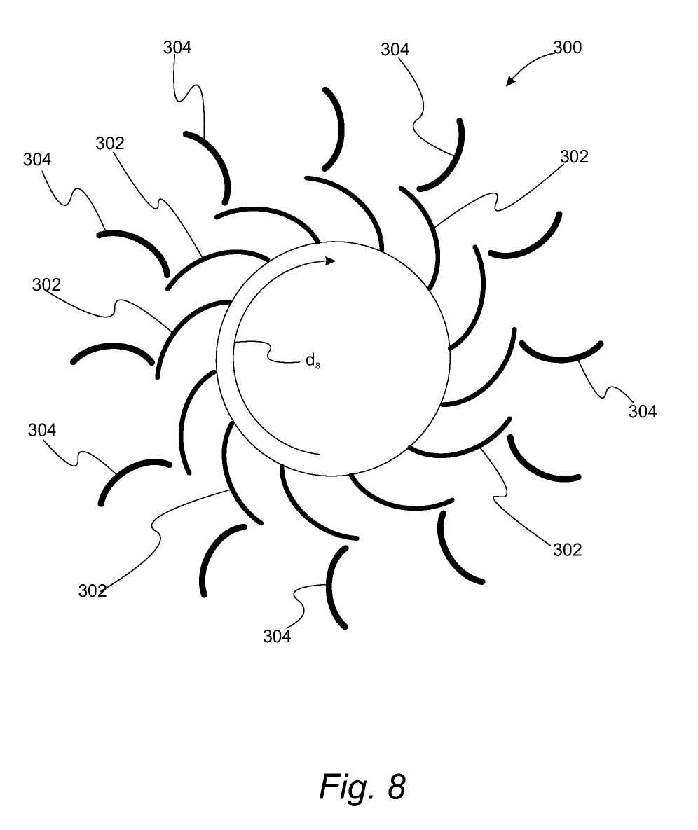

With reference to FIG. 8, a schematic cross section of a fan surrounded by a plurality of stationary stators is provided. Fan 300 includes a plurality of fan blades 302 which are backwardly curved. It should be appreciated that fan blades 302 may be of any design, including, but not limited to, flat fan blades, backwardly curved fan blades, and forwardly curved fan blades. In this variation, the fan rotates along rotation direction d₈. FIG. 8 also illustrates the positioning of stationary backwardly curved stators 304. In a refinement, stators are blade-like. Moreover, stators 304 are mounted within the manifolds set forth above. In a refinement, stators 304 may also be forwardly curved or flat. Stators 304 assist in directing cooling air flow towards the battery modules.

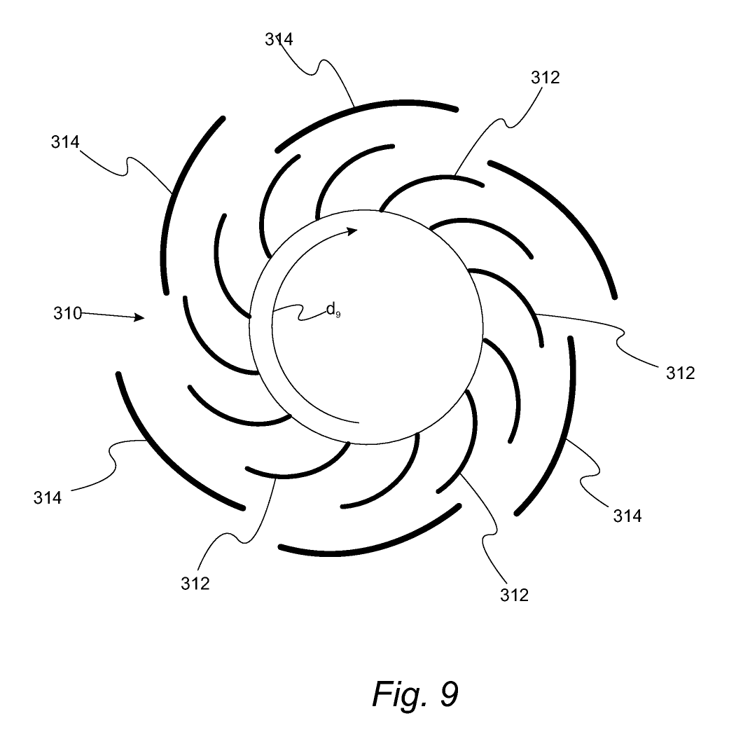

With reference to FIG. 9, a schematic cross section of a fan surrounded by a plurality of stationary volutes is provided. Fan 310 includes a plurality of fan blades 312 which are forwardly curved. It should be appreciated that fan blades 312 may be of any design, including, but not limited to, flat fan blades, backwardly curved fan blades, and forwardly curved fan blades. In this variation, the fan rotates along rotation direction d₈. FIG. 9 also illustrates the positioning of stationary backwardly curved volutes 314. In a refinement stators are plate-like. Moreover, volutes 314 are mounted within the manifolds set forth above. Volutes 314 assist in directing cooling air flow towards the battery modules.

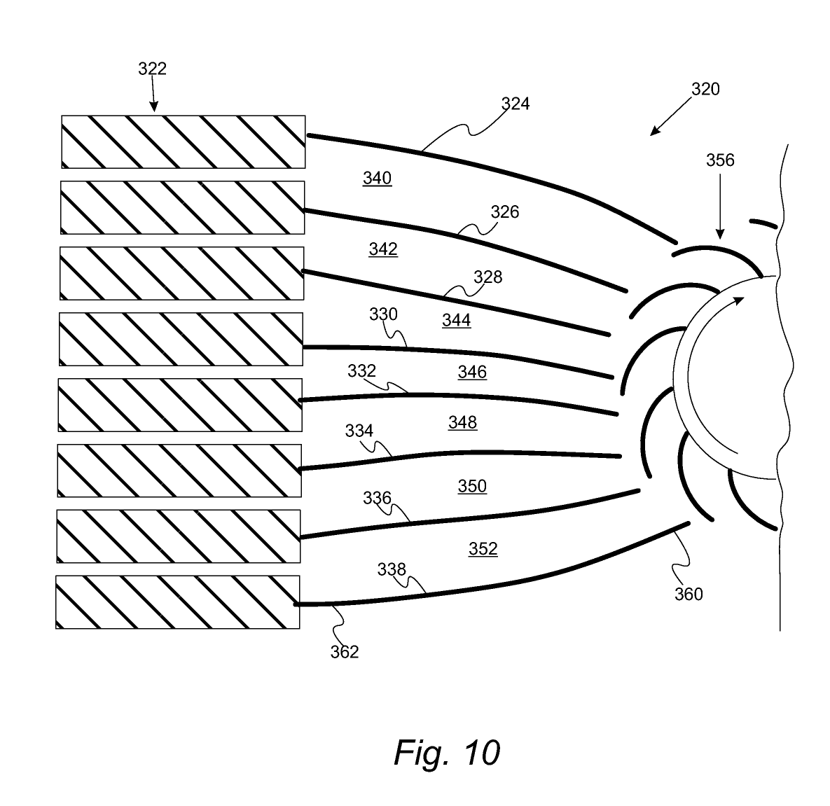

With reference to FIG. 10, a partial schematic illustration of a variation of a cooling system using a plurality of vanes to direct cooling air to the battery modules is provided. Battery pack 320 includes battery module 322 which is of the general design set forth above. Battery pack 320 includes a plurality of vanes 324-338 defining flow channels 340-352 that receive air flow from fan 356 and direct it towards a first battery module 322 and a second battery module (not shown but of the design set forth above). Each of vanes 324-338 independently having a first end 360 proximate to fan 356 and a second end 362 proximate to the first or second battery modules. Vanes 324-338 are typically included in a manifold as set forth above in FIGS. 1-3 and 6.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A battery pack including:
a first battery module including a first plurality of battery cells separated by a first plurality of channels;
a second battery module including a second plurality of battery cells separated by a second plurality of channels;
a fan that creates air flow between the first and second plurality of channels by rotating along a rotation direction; and
a manifold having a first conduit section leading from the fan to the first plurality of channels and a second conduit section leading from the fan to the second plurality of channels, the fan being positioned in the manifold where it creates the air flow that is directed by the manifold to the first plurality of channels and the second plurality of channels.

2. The battery pack of claim 1 further including a battery tray onto which the first battery module, the second battery module, and the manifold are mounted.

3. The battery pack of claim 2 wherein the manifold has a first manifold section and a second manifold section, the fan being mounted in the first section.

4. The battery pack of claim 3 wherein a height of the first manifold section relative to the battery tray is greater than a height of the second manifold section.

5. The battery pack of claim 2 wherein the manifold has a first curved side directing flow from the fan toward the second plurality of channels.

6. The battery pack of claim 5 wherein the manifold includes a first indentation and a second indentation, the first and second indentations reducing stagnant flow regions in the manifold.

7. The battery pack of claim 1 wherein the fan includes a plurality of fan blades that are curved backward relative to the rotation direction.

8. The battery pack of claim 1 wherein the fan includes a plurality of fan blades that are curved forward relative to the rotation direction.

9. The battery pack of claim 1 further including a plurality of stationary stators that receive air flow from the fan and direct it towards the first battery module and the second battery module.

10. The battery pack of claim 1 further including a plurality of unevenly spaced stationary volutes that receive air flow from the fan and direct it towards the first battery module and the second battery module.

11. The battery pack of claim 1 further including a plurality of vanes defining flow channels that receive air flow from the fan and direct it towards the first battery module and the second battery module, the vanes each independently having a first end proximate to the fan and a second end proximate to the first or second battery module.

12. A battery cooling system comprising:
a battery tray for receiving a first battery module and a second battery module, the first battery module including a first plurality of battery cells separated by a first plurality of channels and the a second battery module including a second plurality of battery cells separated by a second plurality of channels;
a fan that creates air flow between the first and second plurality of channels; and
a manifold having a first conduit section leading from the fan to the first plurality of channels and a second conduit section leading from the fan to the second plurality of channels, the fan being positioned in the manifold where it creates the air flow that is directed by the manifold to the first plurality of channels and the second plurality of channels.

13. The battery cooling system of claim 12 wherein the manifold has a first manifold section and a second manifold section, the fan being mounted in the first section.

14. The battery cooling system of claim 12 wherein the manifold has a first curved side directing flow from the fan toward the second plurality of channels.

15. The battery cooling system of claim 14 wherein the manifold include a first indentation and a second indentation, the first and second indentation reducing stagnant flow regions in the manifold.

16. The battery cooling system of claim 13 wherein the fan includes a plurality of curved fan blades.

17. The battery cooling system of claim 13 further including a plurality of stationary stators that receive air flow from the fan and direct it towards the first battery module and the second battery module.

18. The battery cooling system of claim 13 further including a plurality of unevenly spaced stationary volutes that receive air flow from the fan and direct it towards the first battery module and the second battery module.

19. The battery cooling system of claim 13 further including a plurality of vanes defining flow channels that receive air flow from the fan and direct it towards the first battery module and the second battery module, the vanes each independently having a first end proximate to the fan and a second end proximate to the first or second battery module.

20. A battery pack including:
a first battery module including a first plurality of battery cells separated by a first plurality of channels;
a second battery module including a second plurality of battery cells separated by a second plurality of channels;
a fan that creates air flow between the first and second plurality of channels by rotating along a rotation direction; and
a manifold having a first conduit section leading from the fan to the first plurality of channels and a second conduit section leading from the fan to the second plurality of channels, the fan being positioned in the manifold where it creates the air flow that is directed by the manifold to the first plurality of channels and the second plurality of channels, the manifold having a curved side that directs flow towards the second plurality of channels, the manifold also having a first second curved side, a third curved side, and a fourth curved side wherein the first curved side and the second curved side define a first indentation into the manifold and the third curve side and the fourth curved side define a second indentation into the manifold.
